(19) United States
(12) Patent Application Publication
(10) Pub. No.: US 2014/0180870 A1
(43) Pub. Date: Jun. 26, 2014

(54) METHODS, SYSTEMS, AND DEVICES FOR AUTHORIZING PERFORMANCE OF A MEDICAL TASK BY AN IMPLANTABLE MEDICAL DEVICE

(71) Applicant: MEDTRONIC, INC., Minneapolis, MN (US)

(72) Inventors: Charles T. Bombeck, Lino Lakes, MN (US); Duane L. Bourget, Albertville, MN (US); Joel A. Anderson, Brooklyn Park, MN (US); Xuan K. Wei, Minnetonka, MN (US)

(73) Assignee: MEDTRONIC, INC., Minneapolis, MN (US)

(21) Appl. No.: 13/803,591

(22) Filed: Mar. 14, 2013

Related U.S. Application Data
(60) Provisional application No. 61/745,539, filed on Dec. 21, 2012.

(51) Int. Cl. H04L 29/06; G06Q 30/06

(52) U.S. Cl. CPC H04L 63/10; G06Q 30/0609
USPC 705/26.35; 726/4

(57) ABSTRACT

An authorization is required for performance of medical tasks by an implantable medical device (IMD). The authorization may be based on a process implemented by the IMD to check for the authorization. As an alternative, the authorization may be based on a process implemented by an external device, such as to check whether there is authorization to provide a power transmission to the implantable medical device that is necessary for the IMD to perform the medical task. This authorization allows a fee to be charged to performance of the medical task, which in turn allows the initial cost of the IMD to be substantially reduced. This in turn increases the population of patients that are able to afford the IMD to improve their quality of life, which increases the number of IMDs that can ultimately be sold.

### TECHNICAL FIELD

Embodiments relate to the performance of a medical task by an implantable medical device. More particularly, embodiments relate to the authorization of the performance of a medical task.

### BACKGROUND

Medical tasks including electrical stimulation, physiological monitoring, and the like are provided by implantable medical devices (IMDs). For example, electrical stimulation may be provided for various purposes such as treatment for chronic pain, incontinence, and the like. The IMD is purchased in full from the manufacturer by the patient or an insurer and thereafter the performance of the medical tasks by the IMD are not associated with any further fees or payments.

IMDs are a relatively significant expense. Considering that the IMD is being purchased in full, the ability to pay for the device is a hurdle that many potential patients cannot overcome. This is especially true for those who are uninsured or live in locales where a medical insurance industry has not been adequately established, such as in countries with pre-emerging or emerging economies. Therefore, patients in these situations are not benefitting from the IMDs that could improve their quality of life, and the IMD manufacturer is not selling as many IMDs as might otherwise be the case if these patients had the ability to purchase the IMDs.

### SUMMARY

Embodiments address issues such as these and others by providing systems, methods, and devices that are used to authorize the performance of medical tasks by an IMD. By having the performance of the medical tasks be authorized in some fashion, the manufacturer or other entity may then sell the IMD at a reduced price while charging a fee for ongoing usage of the IMD. In this manner, the prohibitive cost of the IMD may be reduced initially and with the initially lost revenue being recovered and perhaps exceeded over time, thereby allowing a larger population of patients to have access to the IMD from improvement of the quality of life and allowing more IMDs to be sold by the manufacturer.

Embodiments provide a medical device that includes a communication circuit that receives external signals and a medical circuit that performs a medical task during a session. The medical device includes a storage element that contains a plurality of session tokens, the session tokens within the storage element having a state that either does authorize a session or a state that does not authorize a session. The medical device also includes a processor in communication with the communication circuit to receive a request for a session, the processor being in communication with the medical circuit to activate and deactivate a session. The processor is in communication with the storage element to access the session tokens, wherein the processor activates the session in response to the request upon detecting that a session token within the storage element has a state that does authorize the session.

Embodiments provide a medical device that includes a communication circuit that receives external signals and a medical circuit that performs a medical task during a session. The medical device includes a storage element that contains a plurality of session tokens and a processor in communication with the communication circuit to receive a request for a session. The processor is in communication with the medical circuit to activate and deactivate a session, the processor being in communication with the storage element to access the session tokens, wherein the processor maintains a pointer directed to one of the session tokens of the plurality and activates the session in response to the request upon detecting that the session token at a current position of the pointer authorizes the session.

Embodiments provide a medical system that includes an external device that receives a request for a session and an implantable medical device that receives the request for the session, that determines whether the requested session is authorized, and upon detecting that the requested session is authorized, then performs a medical task during the requested session. The implantable medical device stores a plurality of session tokens, the session tokens having a state that is either an active state or an inactive state and wherein the implantable medical device detects that the session is authorized by detecting that a session token has the active state.

Embodiments provide a method of performing a medical task during a session that involve receiving a request for the session and detecting whether the requested session is authorized by determining whether a session token of a plurality of session tokens stored within an implantable medical device authorizes the session where at least one of the session tokens of the plurality does not authorize the session. The method further involves, upon detecting that the requested session is authorized, then at the implantable medical device activating the session to perform the medical task.

Embodiments provide a power transmission device for transmitting power to an implantable medical device that utilizes the power to generate stimulation signals. The power transmission device comprises a power transmission circuit and a processor that activates and deactivates the power transmission circuit. The processor detects a trigger to begin a power transmission session, determines whether the power transmission session is authorized, and activates the power transmission when the power transmission session is authorized.

Embodiments provide a method of providing a medical task that involves selling an implantable medical device that performs the medical task at a price less than a price that is charged when the implantable medical device is sold with unrestricted performances of the medical task. The method involves subsequently charging a fee to authorize an amount of performance of the medical task by the implantable device. The method involves, upon charging the fee, sending session tokens to authorize the implantable medical device to perform the medical task. The method also involves detecting at the implantable medical device whether a requested session of performing the medical task is authorized by determining whether a session token of a plurality of session tokens stored within an implantable medical device authorizes the session where at least one of the session tokens of the plurality does not authorize the session, a session token authorizing the session upon the implantable medical device receiving a session token that matches the stored session token.

Embodiments provide a method of providing a medical task that involves selling to a patient an implantable medical device that performs the medical task at a price less than a price that is charged when the implantable medical device is sold with free performances of the medical task, the implantable medical device having a power receiving circuit. The method further involves selling to the patient a first external power transmission device that has a power transmission circuit to provide power to the implantable medical device. The first external power transmission device has a pre-defined amount of power transmission, and the pre-defined amount of power transmission being less than an amount of power transmission needed by the implantable device for a device lifetime. The method additionally involves subsequent to selling the first external power transmission device, selling to the patient a second external power transmission device that has a power transmission circuit to provide power to the implantable medical device. The second external power transmission device has a pre-defined amount of power transmission, and the pre-defined amount of power transmission being less than an amount of power transmission needed by the implantable device for a device lifetime.

### DESCRIPTION OF THE DRAWINGS

FIG. 1 shows an example of an end-to-end system for authorizing performance of medical tasks by an IMD on an on-going basis.

FIG. 2 shows an example of an external device that may be used to exchange information with the IMD and/or to provide power transmission to the IMD.

FIG. 3 shows an example of an IMD that activates and deactivates the performance of medical tasks on the basis of authorization and/or available power.

FIG. 4 shows an example of stored session token values and status of the IMD in comparison to that of a transactional system.

FIG. 5A shows a first example of logical operations performed by the IMD to determine that a session is authorized in order to activate the session.

FIG. 5B shows a second example of logical operations performed by the IMD to determine that a session is authorized in order to activate the session.

FIG. 5C shows a third example of logical operations performed by the IMD to determine that a session is authorized in order to activate the session.

FIG. 6 shows an example of logical operations performed by the external device to request that the IMD start a session and to facilitate the replenishment of session tokens used by the IMD to confirm authorization.

FIG. 7 shows an example of the logical operations performed by the transactional system.

FIG. 8 shows an example of account information maintained by the transactional system and used when completing a transaction to replenish the IMD with session tokens.

FIG. 9 shows an example of logical operations of the external device where authorization of the performance of medical tasks is based on authorization of the external device to provide power transmission to the IMD.

FIG. 10 shows an example of the sales procedure implemented where the IMD detects whether it is authorized to perform the medical task.

FIG. 11 shows an example of the sales procedure implemented where the authorization for the IMD to perform the medical task is based on external devices detecting whether the ability to transfer power to the IMD has expired.

FIG. 12 shows an example of a procedure to account for unused session tokens within an IMD that becomes unusable.

### DETAILED DESCRIPTION

Embodiments provide for the activation of sessions where a medical task is performed by an implantable medical device (IMD) based on whether the session is authorized. In accordance with some embodiments, the authorization of a given session may be determined by the IMD. In accordance with other embodiments, the authorization may be determined by an external device such as where the external device provides a power transmission to the IMD to allow the session to become active. By requiring an authorization for the activation of a session, a fee may be charged to provide the authorization, thereby providing a source of revenue subsequent to the initial purchase of the IMD. These subsequent fees to authorize the activation of sessions may allow for a lower price to be charged for the purchase of the IMD, thereby increasing the population of patients with the ability to purchase the IMD.

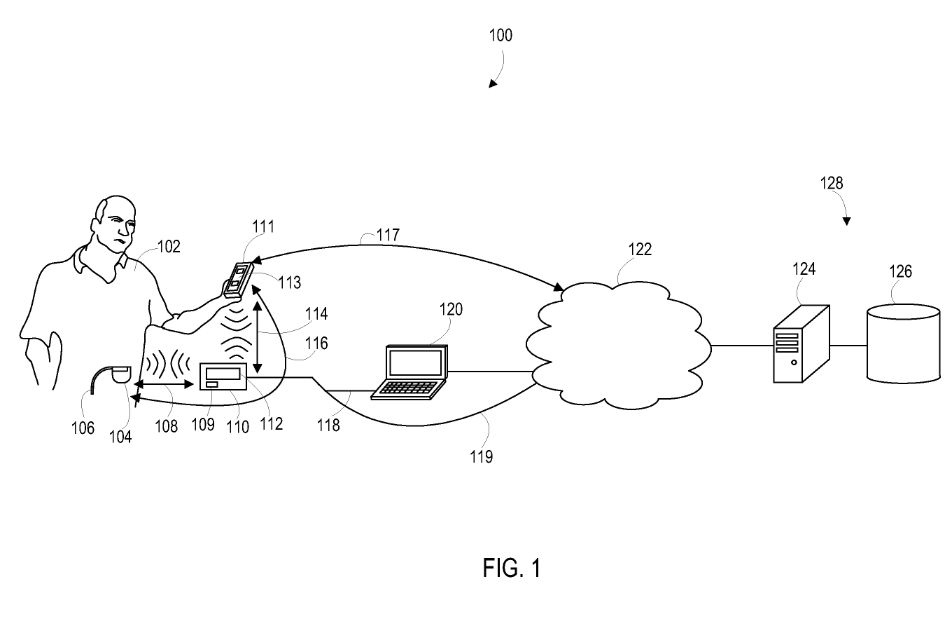

FIG. 1 shows an example of an operating environment for the various embodiments. In this example, a patient 102 has purchased the IMD 104 in order to benefit from the medical task(s) that the IMD 104 may perform. For instance, the IMD 104 may provide electrical stimulation therapy or may collect physiological data of interest for the patient via an electrical lead 106 that is coupled to the IMD 104.

The patient 102 also possesses one or more external devices that may be used to communicate with and control the IMD 104. For instance, an external device 110 may be used to communicate directly with the IMD 104 through a wireless communication 108, such as an inductively coupled near field or arm's length communication link. Alternatively, the external device 110 may communicate with the IMD 104 through a far field communication. In either case, the communications may be encrypted. This external device 110 may serve the dedicated purpose of communication and control with the IMD 104, and may provide a user interface 112 that the patient 102 may touch to initiate activation of a session by the IMD 104.

As an alternative to the patient 102 interacting directly with the external device 110, the patient 104 may also possess a smartphone, tablet, or other similar computing device 111 that provides a user interface 113. While this computing device 111 may be a general purpose device, a particular application program may be implemented on the computing device 111 such that the patient 102 may interact with the user interface 113 to control the IMD 104. In order to deliver commands to the IMD 104, the computing device 111 may communicate directly with the external device 110 via a wireless communication 114 such as a near field or far field communication that may be encrypted, where the external device 110 then relays the commands to the IMD 104 via the wireless communications 108. As another alternative, the computing device 111 may have near field communication abilities to match those of the IMD 104 and/or the IMD 104 may have far field communication abilities to match those of the computing device 111 such that the two communicate directly via wireless communication 116 which may be encrypted.

In addition to utilizing communications to deliver commands to the IMD 104, the IMD 104 may utilize communications to deliver information back to the external device 110 and/or the computing device 111. For example, the IMD 104 may need to report that the amount of remaining sessions is reaching a low number or has reached zero such that a replenishment event is needed. In such a case, the external device 110 and/or computing device 111 may annunciate this condition in some manner that is perceived by the patient 102, such as by illuminating a light 109 or providing a display on the user interface 112 or producing an audible alert. As an alternative, the external device 110 and/or computing device 111 may be configured to automatically initiate a replenishment event upon receiving the notification from the IMD 104.

For embodiments where the external device 110 provides power transmission to the IMD 104 to enable the IMD 104 to activate the session and perform the medical task(s), the external device 110 may determine whether the power transmission is authorized. In that case, the external device 110 may produce the annunciation to the patient 102 upon the external device 110 detecting that the number of available sessions is approaching or has reached zero.

According to some embodiments, in order to replenish either the IMD 104 or the external device 110 to allow for additional sessions to occur, a transaction is triggered by communications through a network 122 such as the Internet which carries the communications to a remotely located transactional system 128 that includes a computer system 124 such as one or more server computers that have access to a database 126 containing account and authorization information. The external device 110 may communicate directly via a wired or wireless connection 118 with a computer system 120 with a connection to the network 122 or with the computing device 111 which may also have such a connection 117 to the network 122. Furthermore, the external device 110 of some embodiments may include long range communication abilities 119, such as cellular communication abilities, and may communicate directly through the network 122 to the transaction system 128. Alternatively, the patient 102 may interact directly with the computing device 111 or computer system 120 or may place a phone call to initiate communications with the transactional system 128.

The transactional system 128 processes a monetary transaction to ultimately return information to the IMD 104 or external device 110 to authorize additional sessions. The patient 102 maintains an account with the transactional system 128 which allows the transactional system 128 to charge the patient 102 for the additional sessions and to return information that may be specific to the particular IMD 104 or external device 110 that the patient 102 possesses. The authorization information, the account information, and the procedure for completing the transaction are discussed in more detail below.

For the embodiments where the external device 110 provides power transmission to the IMD 104 and controls the authorization of the session by determining whether to activate the power transmission, an alternative to receiving authorization from the transaction system 128 is provided. In this alternative, once the external device 110 reaches zero available sessions for power transfer and annunciates this condition to the patient 102, the patient 102 then proceeds to purchase a replacement external device 110 that has a pre-defined amount of power transmission sessions. This replacement external device 110 is then used to transmit power to the IMD 104 to enable the IMD 104 to proceed with performing the medical task during a session.

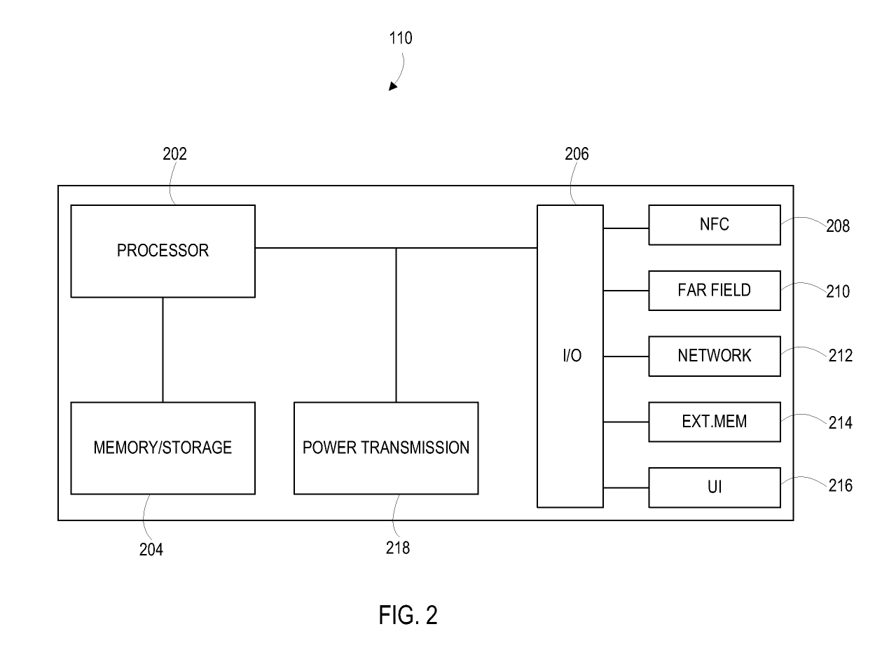

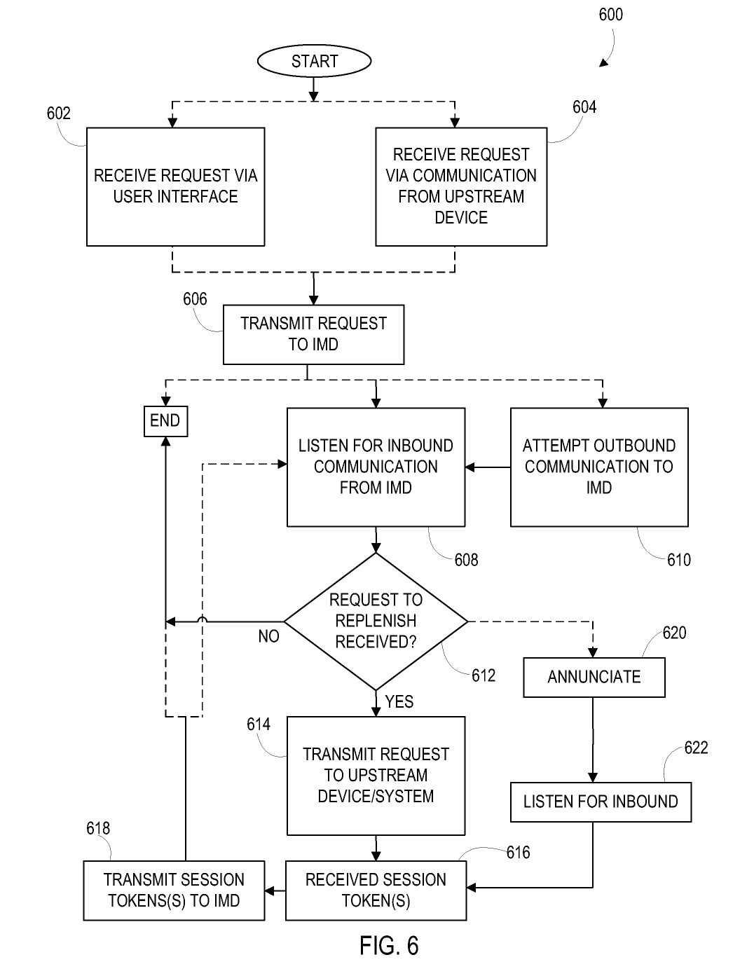

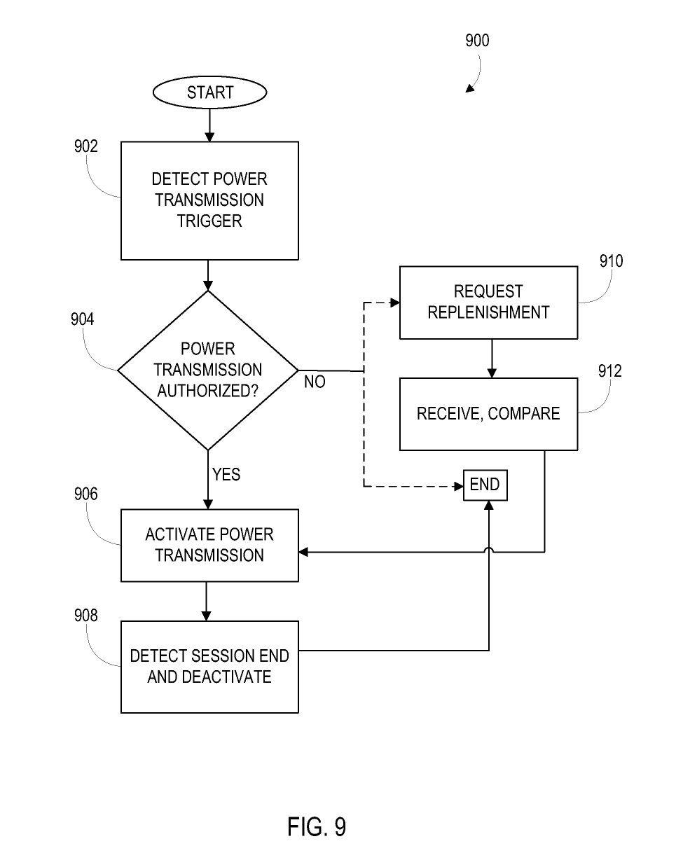

An example of the external device 110 according to the various embodiments described above is shown in FIG. 2. The external device 110 includes various components such as a processor 202 coupled to or integrated with a memory serving as a storage 204 element. The processor 202 may be one of a variety of forms such as a general-purpose programmable processor, a dedicated-purpose application-specific processor, hardwired digital logic, and the like. The processor performs logical operations to provide the functions discussed above. These logical operations are discussed in more detail below with reference to FIGS. 6 and 9.

The processor 202 is coupled to input/output (I/O) circuitry 206 that provides the processor 202 with the ability to pass data into and out of the external device 110. Various embodiments may provide for different components interfaced to the I/O circuitry. For instance, the I/O circuitry 206 may interface with a near field communication circuit 208 that allows for close range inductive coupling to the IMD 104 and/or computing device 111 in some embodiments. The I/O circuitry 206 may interface with a far field communication circuit 210, for example a Medical Implant Communication Service (MICS) band capable circuit to allow for extended range for the communications with the IMD 104 and/or computing device 111 in some embodiments.

In addition to circuitry for communicating with the IMD 104, the I/O circuitry 206 may interface with a networking circuit 212, such as an Ethernet connection, a Wi-Fi wireless connection, or a cellular connection in some embodiments. This allows the external device 110 to interface with the computing device 111, the computer system 120, and/or directly through the network 122.

The I/O circuitry 206 may also interface with an external memory reader 214 according to some embodiments. The physical transport and delivery of external memory devices are one manner of delivering information that authorizes additional sessions by the IMD 104 from the transactional system to the external device 110. For instance, the external memory reader 214 may accept universal serial bus devices, secure memory (SD) cards, and the like, and/or read from RFID chips embedded in cards or tags, which then allows the processor 202 to access the contents of those memory devices.

The I/O circuitry 206 may also interface with a user interface circuit 216. The user interface circuit 216 establishes the user interface that the patient 102 may view and/or manually manipulate to receive notifications from the external device 110 and to provide commands to the external device. Examples may include a display screen, a touchscreen, physical buttons, light emitting diodes or other light sources, speakers for producing audible information and the like.

The external device 110 may also include a power transmission circuit 218 according to various embodiments. The power transmission circuit 218 may be activated by the processor 202 to provide power through an inductive coupling to the IMD 104. The power transmission may be to recharge a battery of the IMD 104 according to some embodiments, or may alternatively provide real time power for operation of the IMD 104 where the IMD 104 lacks a power source.

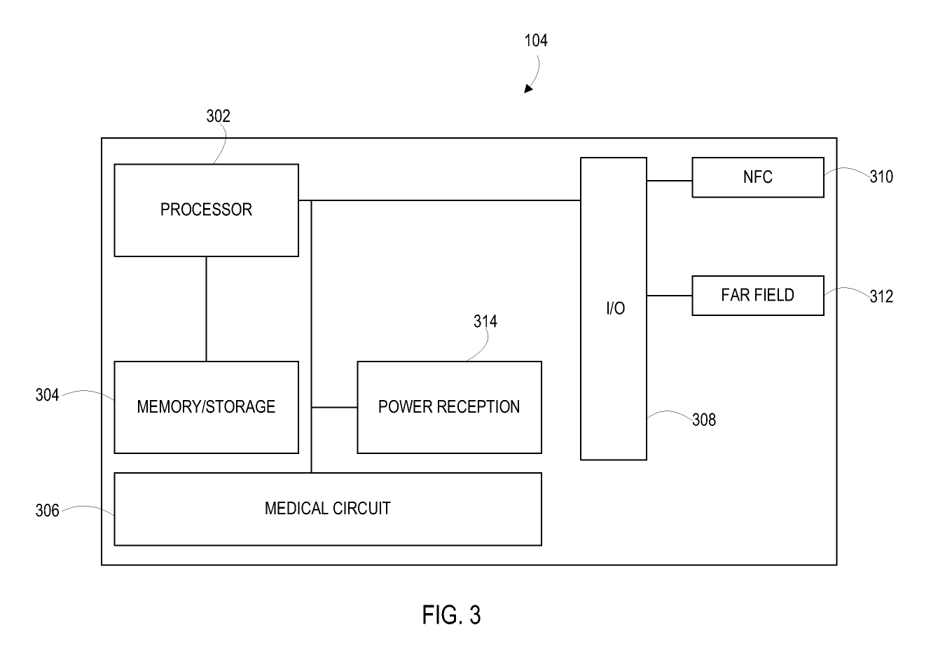

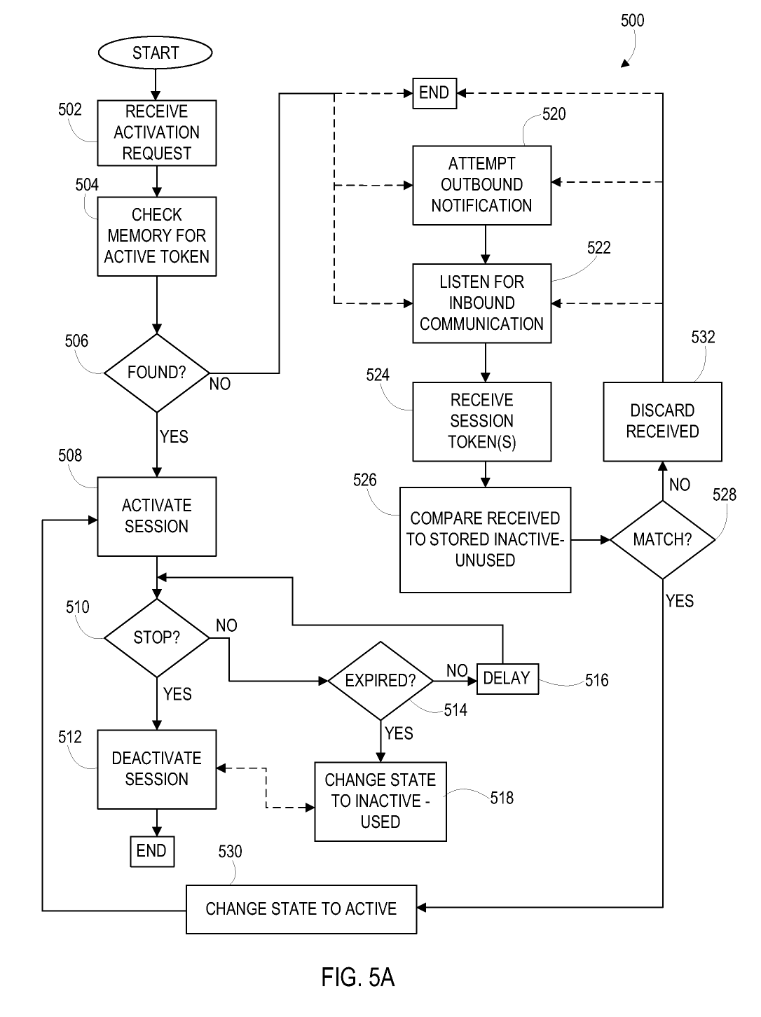

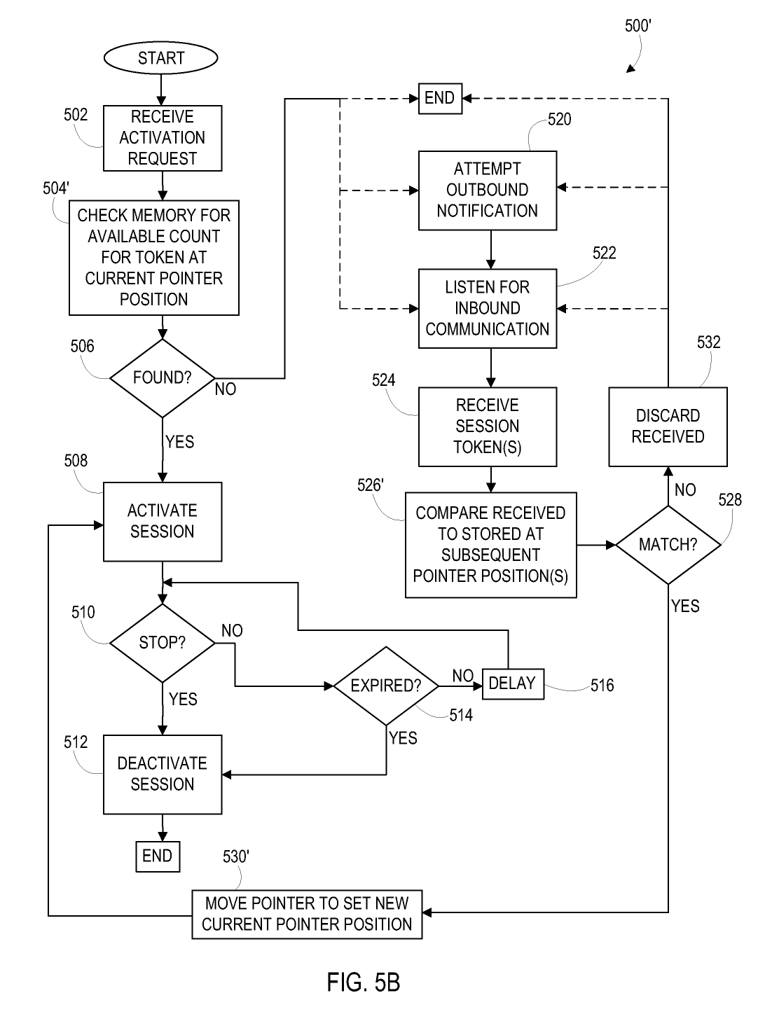

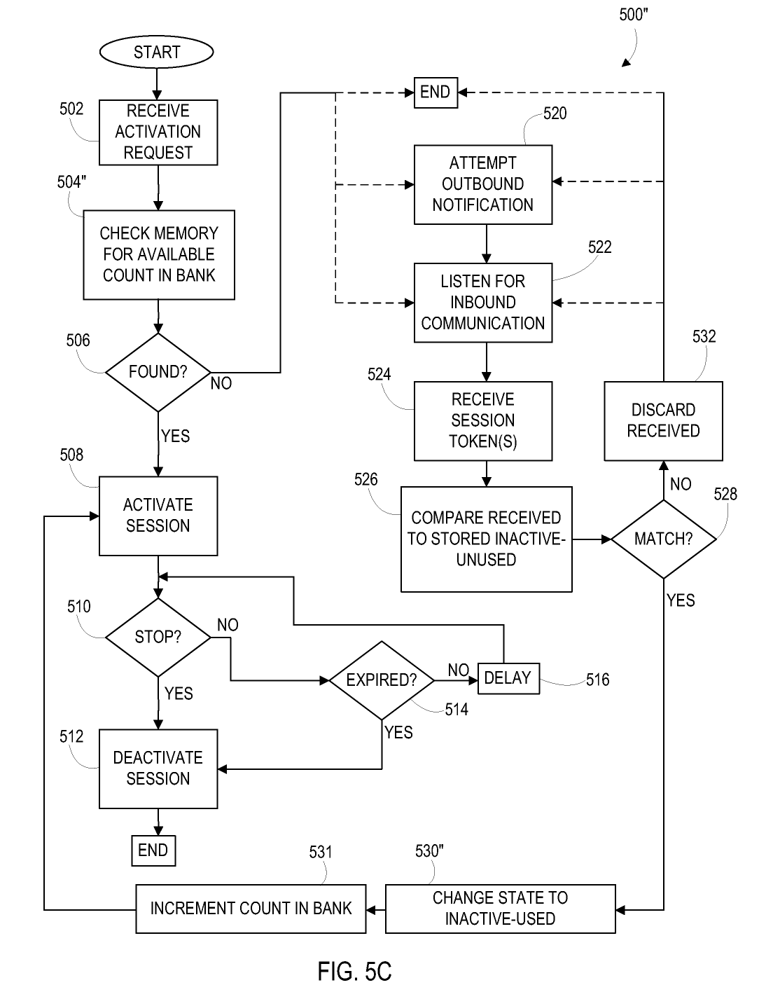

An example of the IMD 104 according to the various embodiments described above is shown in FIG. 3. The IMD 104 also includes various components such as a processor 302 coupled to or integrated with a memory serving as a non-volatile storage 304 element. The processor 302 may also be one of a variety of forms such as a general-purpose programmable processor, a dedicated-purpose application-specific processor, hardwired digital logic, and the like. The processor performs logical operations to provide the functions discussed above. Various examples of these logical operations are discussed in more detail below with reference to FIGS. 5A-5C.

The processor 302 is coupled to input/output (I/O) circuitry 308 that provides the processor 302 with the ability to pass data into and out of the IMD 104. Various embodiments may provide for different components interfaced to the I/O circuitry 308. For instance, the I/O circuitry 308 interfaces with one or more types of communication circuits. One type of communication circuit that may be included is a near field communication circuit 310 that allows for close range inductive coupling to the external device 110 and/or computing device 111 in some embodiments. The I/O circuitry 308 may additionally or alternatively interface with other types of communication circuits such as a far field communication circuit 312, for example a MICS band capable circuit to allow for extended range for the communications with the external device 111 and/or computing device 111 in some embodiments.

The IMD 104 also includes a medical circuit 306 that performs the medical task(s) for the patient 102. For instance, the medical circuit 306 may provide electrical stimulation therapy. As another example, the medical circuit 306 may provide physiological sensing. The processor 302 activates and deactivates the medical circuit 306 to thereby control whether a session of performing the medical task(s) occurs. According to some embodiments, upon the processor 302 receiving a request for the session, the processor 302 then accesses information in the storage element 304 to determine whether the requested session is authorized.

According to other embodiments, the processor 302 may activate the session without checking for authorization because the authorization has been performed by an external device that has allowed the IMD 104 to remain operational by providing the necessary recharge or real time power. The IMD 104 receives the recharge or real time power transmission via a power reception circuit 314. This power reception circuit 314 may include a rechargeable battery that receives the recharge power, or alternatively, the power reception circuit 314 may distribute the power in real time to the components of the IMD 104 to maintain the IMD 104 in an operational state.

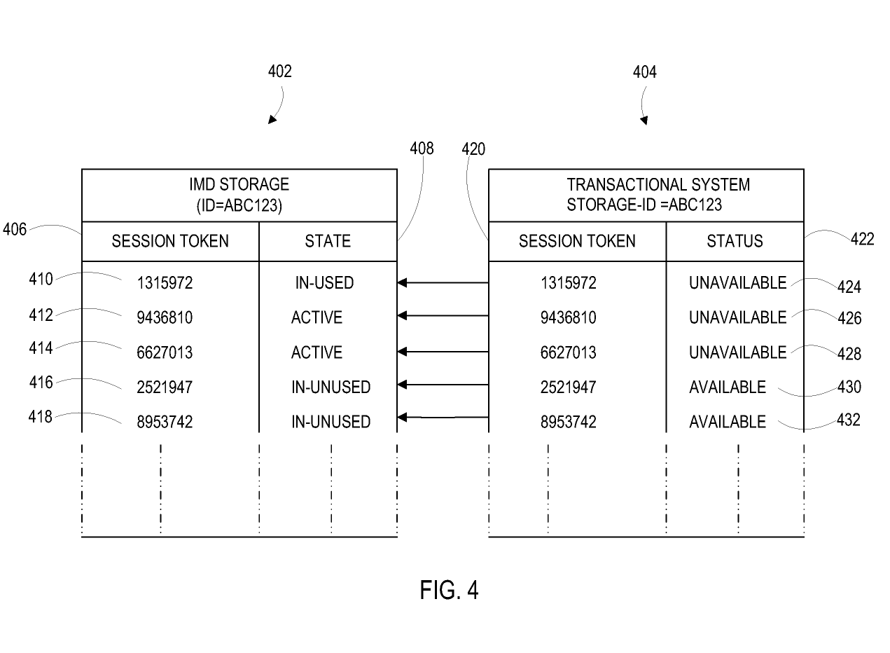

FIG. 4 shows one example of at least some of the contents of the IMD storage element 304 that the IMD 104 may use to authorize a session of performing the medical task(s). FIG. 4 also shows one example of at least some of the contents of the database 126 of the transactional system 128 for replenishing the availability of sessions for the IMD 104. A data structure 402 of the IMD storage element 304 includes a set 406 of session tokens 410-418, with each session token having a specified state 408. Similarly, the data structure 404 of the database 126 includes a set 420 of session tokens 424-432 that are designated for and unique to a specific and individual IMD 104 as identified by a device ID, and these session tokens 424-432 have a defined status 422.

The session tokens of the data structure 402 are a match to the session tokens designated for the specific and individual IMD 104 in the data structure 404. During manufacturing of the IMD 104, the session tokens are generated specifically for this particular IMD 104, are programmed into the storage element 304 of this particular IMD 104, and are saved into the database 126 in association with the device ID of this particular IMD 104. Thus, in this example, the session tokens in the data structure 402 of the IMD 104 are an exact match to the session tokens in the data structure 404 designated for the IMD 104. The session tokens may be generated as a sequence of random numbers or as the outcome of an algorithm that the manufacturer maintains as a secret, with the length of the sequence being chosen as desired to balance the degree of security expected and the number of IMDs to be differentiated with the amount of memory space to occupy within the IMDs. In any event, no two IMDs will have the same set of session tokens.

Initially, the status of the session tokens in the data structure 404 are available while the state of the session tokens in the data structure 402 are inactive-unused. The available status within the data structure 404 indicates that the session tokens are available for purchase as the same session token in the data structure 402 is in the initial state of inactive-unused. The inactive-unused state of the session tokens in the data structure 402 indicates that the session tokens are not capable of authorizing a session of performance of the medical task.

Upon the patient purchasing usage of the IMD 104, the session tokens that authorize such usage are marked within the data structure 404 as unavailable and those session tokens that have been purchased are delivered to the IMD 104 through a series of electronic communications back to the external devices or through physical delivery of a memory device containing the session tokens. Because the session tokens being delivered are only relevant to the IMD 104 that also has a copy of those same tokens stored and are only used for one period of being active by the IMD 104, security of the transfer of the tokens is not of particular concern.

Upon the IMD 104 receiving the session tokens, the IMD 104 checks to find the matching session tokens already present in the data structure 402. The IMD 104 then changes the status of the matching session tokens already present in the data structure 402 to active. The IMD 104 may then rely on one of the active session tokens to authorize a session for performance of the medical task(s).

The IMD 104 may use the token itself, a combination of the token plus the tokens preceding or following the token in the data structure, the position of the token within the series of tokens comprising the data structure, or a combination of these for verifying its presence of the token in the data structure. Thus, more information than the token itself may be transferred to the IMD 104 for the purpose of verifying the token. This will allow the number of digits in the tokens to be reduced while not hindering security and thus require less memory within the IMD 104.

The IMD 104 also has a counter that may be present in the storage element 304 that the IMD 104 uses to monitor the usage of a given session token. The session token may be used to authorize a certain number of sessions, to authorize a certain amount of session time, or to authorize a period of time during which sessions can be performed such as a number of months or days. In these cases, the counter keeps track of the amount of usage remaining for the session token currently being used to authorize the session or the amount of the time period that is remaining. Once the amount of use or remaining time period provided by the session token has been depleted to zero, the IMD 104 then changes the state of the session token to inactive-used and then no longer relies on that session token for authorization. If all session tokens that have been active become inactive-used, then the IMD 104 no longer has authorization to activate a session and a purchase of usage of the IMD 104 in the form of purchasing additional session tokens from the transactional system 128 is necessary.

One example of operations 500 performed by the IMD 104 to determine if activation of a session is authorized and to participate in the purchasing of additional session tokens when needed to allow for such activation are shown in FIG. 5A. The IMD 104 receives an activation request from an external device at a request operation 502. The IMD 104 checks the storage element 304 for an active session token at memory operation 504. At query operation 506, it is detected whether an active session token has been found. The IMD may first look for an active session token that has been depleted to some degree in order to continue using that active session token until it is fully depleted. If a partially depleted active token is not found, the IMD 104 may proceed to the next available unused active session token.

If an active session token is found, then the IMD 104 activates the medical circuit to perform the medical task for a current session at activation operation 508. The IMD 104 also begins decrementing the count stored for the active session token, such as decrementing the amount of use remaining. If the count is an amount of time remaining in an authorized time period, then a countdown of the time period remaining is initiated if this is a first use of this session token and if a subsequent use then the countdown of time merely continues. If the session token represents a particular number of sessions, then the IMD 104 decrements that number of available sessions by one, and if that count reaches zero the IMD 104 changes the state for the session token to inactive, used at state operation 518. If the session token represents an amount of session time, then the IMD 104 begins decrementing the remaining time. During the session the patient 102 may choose to pause the session, and the IMD 104 may then pause the countdown of the remaining time until the patient unpauses the session. However, according to some embodiments, the session countdown may restart after a certain period of time if the patient does not unpause the session. The IMD 104 also listens for a stop command from the external device at a query operation 510 while the session is activated. Once a stop command is received the IMD 104 then deactivates the medical circuit to terminate performance of the medical task(s) at a deactivation operation 512.

If a stop command has yet to be received at query operation 510, then the IMD 104 determines at a query operation 514 whether the session has expired. For instance, the session may have a set amount of time that it may remain activated and the session expires once that set amount of time has elapsed. Furthermore, where the count stored for the session token represents a remaining amount of session time, expiration of the session occurs once that count has reached zero. If the session has yet to expire, then after a brief delay period 516, the IMD 104 again queries for whether a stop command has been received or whether the session has expired. Once the session has expired, the IMD 104 then changes the state to inactive-used, if not already changed, and deactivates the medical circuit at the deactivation operation 512.

Returning to query operation 506, if no active session token has been found, the operations may reach the end without further action according to some embodiments. According to other embodiments, the IMD 104 may attempt an outbound communication to an external device to indicate that no active session tokens are available and that the request is denied at a notification operation 520. Then the IMD 104 may begin listening for an inbound communication that may be in response to the outbound communication at a communication operation 522. As another alternative, rather than sending an outbound communication, the IMD 104 may directly begin listening for the inbound communication.

Eventually, assuming the patient 102 decides to purchase additional usage of the IMD 104, the IMD 104 receives a communication that includes additional session tokens at a reception operation 524. The IMD 104 compares the received session tokens to the session tokens already stored by the IMD 104 that have the inactive-unused status at a comparison operation 526. By limiting the comparison to those stored session tokens that have the inactive-unused status, the IMD 104 eliminates the possibility of having a used session token being made active again, which in turn prevents someone who may have eavesdropped on a prior session token transmission from attempting to send a copy of a used session token back to the IMD 104. Thus, there is theft and fraud prevention built into this procedure for making session tokens stored at the IMD 104 active.

The IMD 104 determines from the comparison whether the received session token matches any of the inactive-unused session tokens stored by the IMD 104 at a query operation 528. If there is no match, the received session token is discarded at a discard operation 532 and the operations either end or return to the notification operation 520 or the communication operation 522. If there is a match, then for the stored session token that matches the received session token the IMD 104 changes the state from inactive-unused to active at a state operation 530. At this point, an active session token is now available such that the current request for an active session may be granted by activating the medical circuit at the activation operation 508.

As an alternative to the data structure of FIG. 4 and the operations of FIG. 5A that involve storing a state in association with each session token, the IMD 104 and the transactional system 128 may instead rely on a pointer within the list of session tokens to keep track of which session token to consider active versus inactive. Session tokens closer to the beginning of the list than the pointer are considered used and therefore permanently inactive while tokens after the pointer are considered to be usable and therefore potentially active in the future.

An example of this implementation is shown in the operations 500′ of FIG. 5B which match the operations 500 of FIG. 5A except where noted. The IMD 104 checks for an available count for a token at a current pointer position at a count operation 504′. The operations then proceed. When a session token is received from the transactional system 128 at the operation 524, the IMD 104 then compares the received session token to a usable session token by looking down the list from the current pointer position to find the match, if any at a comparison operation 526′. The IMD 104 may be configured to look beyond the next session token in the list in case the next token(s) have been previously sent but not downloaded to the IMD 104 due to being lost, forgotten, and the like. However, the IMD 104 may be configured to only look for a match within only a certain number of session tokens down the list from the current pointer location, rather than searching the entire list. Upon reaching the match, if any, the pointer is moved to that matching session token in the list at a pointer operation 530′ to thereby begin using that session token to authorize a session. The IMD 104 also begins the countdown of the amount of usage or amount of time represented by that matching session token. Furthermore, because states are not being maintained, upon expiration of the count for a token at the query operation 514, the session is deactivated at deactivation operation 512 without the need to alter a token state.

In another implementation shown in FIG. 5C, at least a used and unused state of the tokens are managed and where a bank of usage is also tracked in memory. The operations 500″ of FIG. 5C match the operations 500 of FIG. 5A except where noted. The IMD 104 checks for an available count within the bank at a current pointer position at a bank operation 504″. The operations then proceed. When a received session token(s) is found to match a stored session token(s) at query operation 528, then the state of the token(s) is changed to used at a token operation 530″. The count of the bank is then incremented to reflect the amount of usage represented by the token(s) at a bank operation 531. Furthermore, because an active state is not being maintained due to a token being changed from unused to used when incrementing the count of the bank, upon expiration of the count for the bank at the query operation 514, the session is deactivated at deactivation operation 512 without the need to alter a token state.

FIG. 6 shows a one example of a set of operations 600 that may be performed by the external device 110. Initially, the device 110 may receive a request from the patient 102 to start a session of performance of the medical task(s) at a request operation 602 through the user interface of the device 110 if so equipped. Alternatively, the external device 110 may receive the request for the session in the form of a communication from an upstream device, such as the computing device 111 at a request operation 604. In either case, the external device 110 then transmits the request to the IMD 104 at a transmission operation 606.

At this point, various embodiments of the external device 110 provide for different operations. In one example, the operations may simply end. In another example, the external device 110 may attempt an outbound communication to the IMD 104 to provoke the IMD 104 to report whether there are active session tokens available for the requested session at a communication operation 610. The external device 110 then listens for a responsive inbound communication from the IMD 104 at a communication operation 608. As another alternative, the external device 110 may rely on the IMD 104 to report back without being provoked such that the external device 110 begins listening for an inbound communication at the communication operation 608 without having sent any outbound communication.

The external device determines whether a response from the IMD 104 requests that the session tokens be replenished due to a low number of or complete absence of active session tokens at a query operation 612. If no such request is received, then the operations cease. If a request is received, then the external device 110 may then transmit a request for token replenishment to an upstream device or system at a request operation 614. For example, the device 110 may communicate with an application program on the computing device 111 or the computer system 120 to cause a transaction to be placed with the transactional system 128. Alternatively, the external device 110 may be equipped to communicate the transaction request directly to the transactional system 128.

Upon transmitting the request, the external device 110 then receives the session tokens that have been provided by the transactional system 128 in response to the transaction request at a reception operation 616. The tokens may be delivered via electronic communications back through the chain of devices that submitted the request. The external device 110 then transmits the session tokens to the IMD 104 at a transmission operation 618.

As an alternative to the external device 110 communicating a request to upstream devices, the external device 110 may annunciate that the IMD 104 has a low number of or has been depleted of active session tokens at an annunciation operation 620. The annunciation may be an audible and/or visual indicator perceived by the patient 102. The patient 102 may then proceed to submit the transaction request to the transactional system 128 in one of various ways. For instance, the patient 102 may utilize the computing device 111 or computer system 120 to submit the request as an electronic data communication, or the patient 102 may place a phone call to submit the request.

Upon annunciating the need for more active session tokens, the external device 110 may begin listening for an inbound source of session tokens at a listen operation 622. The inbound source may be of various forms, such as an electronic communication from an upstream device according to some embodiments. The inbound source may alternatively be an external memory device that is presented to the external device 110, such as a USB or SD flash drive, an RFID tag, a self-powered dongle capable of short range communication and the like that provides the session tokens to the external device 110. The external device 110 then proceeds as described above by receiving the session tokens and transferring them to the IMD 104.

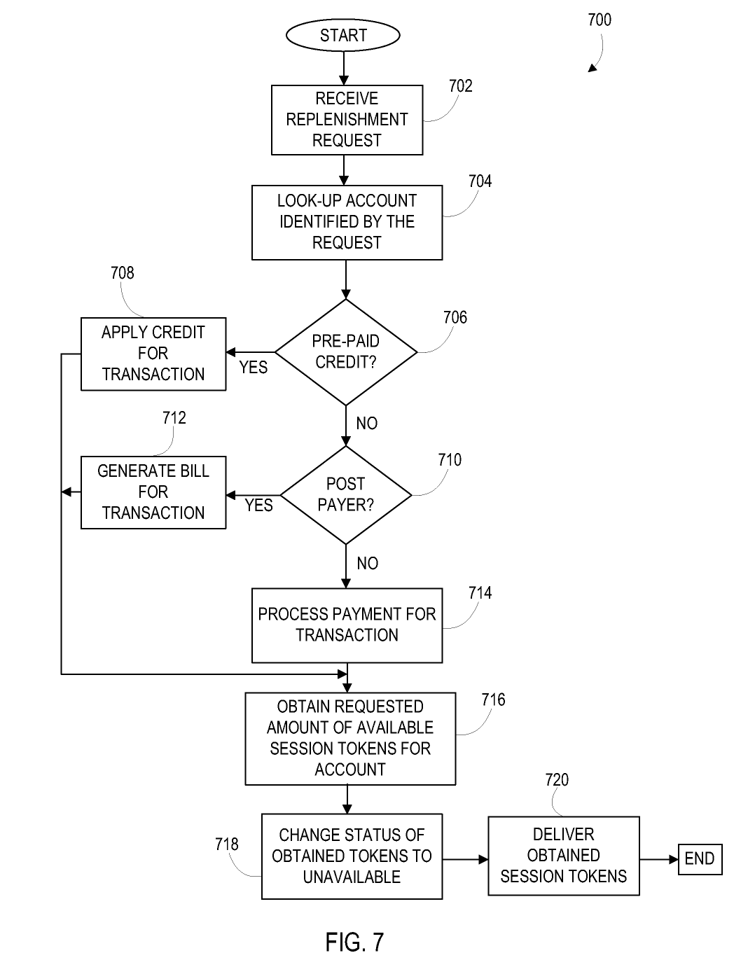

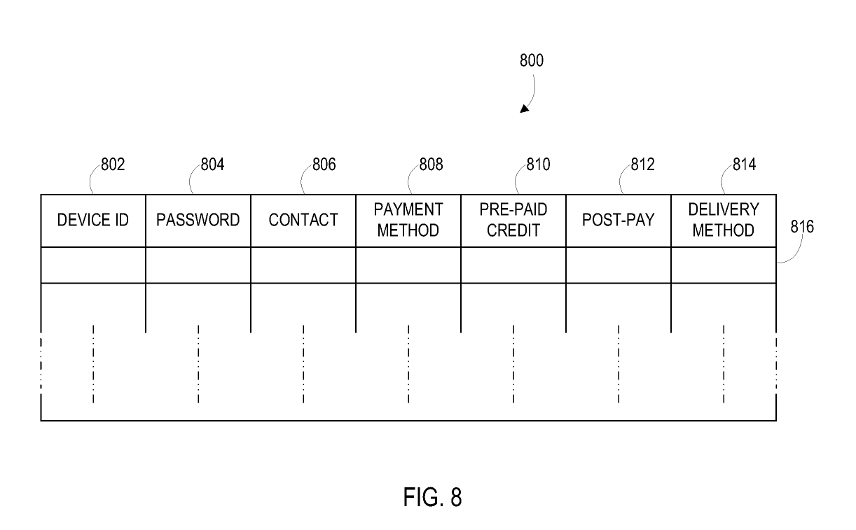

FIG. 7 shows one example of a set of operations 700 that may be performed by the transactional system to complete the transaction for purchasing additional IMD usage in the form of session tokens. The account of the patient 102 and his or her particular IMD 104 has already been established and is discussed in more below with reference to FIG. 8. Thus, the operations 700 may proceed with respect to that account information. Initially, the system 128 receives the replenishment transaction request at a request operation 702. As discussed above the request may be provided as an electronic data communication from a downstream device of the patient 102 or may be a phone call from the patient 102. The request identifies the account of the patient 102 in some manner, such as by providing the unique device ID of the IMD 104 and/or providing other information such as a password specified by the patient 102 for the account.

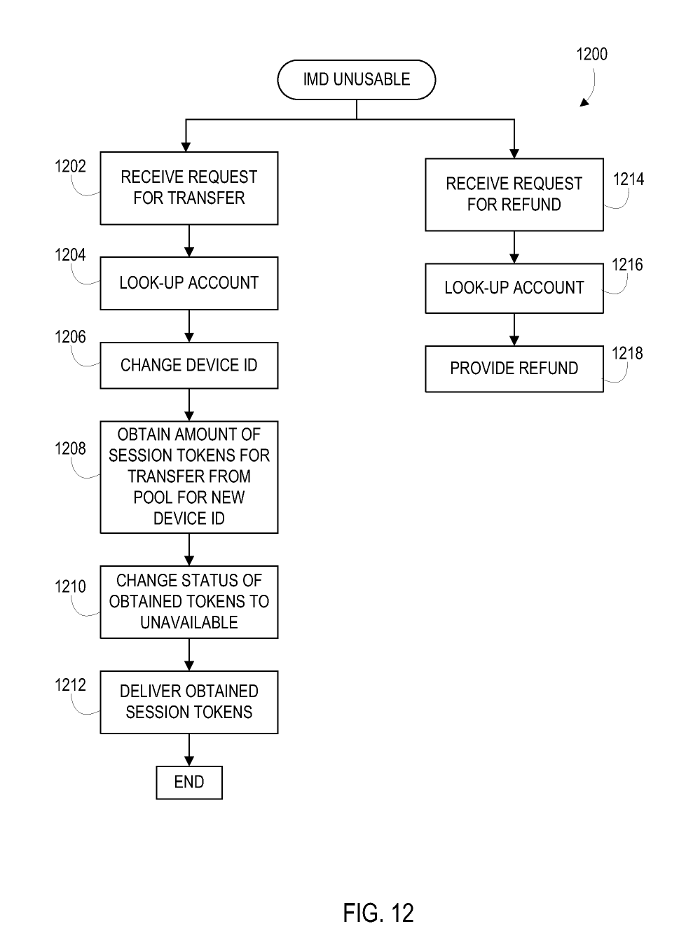

Upon receiving the request, the transactional system then performs a look-up of the account that has been identified by the request at a look-up operation 704. From the account information for the patient 102, the transactional system 128 may then determine whether the patient 102 is a pre-paid customer with a credit, a post pay customer who can be billed, or a current pay customer who has provided a payment method. The look-up may also determine whether the device has reached or is about to reach an end of service life. In that case, rather than processing the transaction, the transactional system may return a disclaimer and release to the patient and may require an acceptance of the disclaimer and release about the device being out of the service life via a user interface selection in order to process the transaction. The disclaimer may also provide the user the option to process the transaction for a replacement device, the details of which are discussed in more detail below with reference to FIG. 12. Where only a portion of the requested session tokens will result in use beyond the service life of the medical device, then the transaction system may normally process the transaction for the session tokens that will not extend use beyond the service life and then provide the disclaimer and release in relation to the portion of session tokens that will extend use beyond the service life.

For normal processing of the service request, query operation 706 detects whether the patient 102 has a pre-paid credit that may be applied and if so, applies the credit for the transaction at a transaction operation 708. Query operation 710 detects whether the patient 102 is a post-payer and if so, proceeds to generate a bill for the transaction at a billing operation 712. If neither is the case, then the patient 102 is a current payer and the transactional system 128 processes the payment for the transaction using the specified payment method at a payment operation 714.

Upon the credit, bill, or payment occurring, the transactional system 128 then obtains the requested amount of available session tokens for the account at a token operation 716. The database 126 may store the session tokens that are specific to the IMD 104 of the patient 102 in conjunction with the account information or otherwise store the session tokens separately but identified as corresponding to the IMD 104 of the patient 102. The transactional system selects the desired number of session tokens from those that have the available status, indicating that they have not already been presented to the IMD 104 which means the IMD 104 will be willing to accept them as valid session tokens.

The session tokens may all represent the same amount of usage, such as a set number of sessions or a set amount of time. Thus, the patient 102 may purchase a desired number of sessions or a desired amount of session time and the transactional system 128 then responds with the appropriate number of session tokens. As an alternative, session tokens may represent differing amounts of usage, where one session token may correspond to one number of sessions or amount of session time while another session token may correspond to a different number of sessions or a different amount of session time. In that case, the amount of usage may be appended to the session token or may be inherent to the numerical values of the session token, such as particular digits within the session token representing a number of sessions or a number of session minutes that are authorized. Furthermore, the transactional system 128 may offer volume discounting where the price of the usage decreases as the amount of usage being purchased increases.

The transactional system 128 changes the status of the obtained session tokens from available to unavailable to reflect that they have now been purchased and transferred at a status operation 718. The transactional system 128 then delivers the session tokens at a delivery operation 720. The delivery may involve sending the tokens within an electronic communication to a downstream device, or may involve the physical shipment of a memory device containing the session tokens.

FIG. 8 shows an example the account data structure 800 that may be stored within the database 126. The account information may be established by the patient 102 upon purchasing the IMD 104, such as via a website accessed on a computer. Furthermore, the medical facility that has implanted the IMD 104 may set up the account on behalf of the patient 102. Within the data structure, each patient 102 corresponds to a row 816. Several categories of information may be stored for each patient 102. A first category is a device ID 802 that is the unique identifier of the IMD 104 of each patient 102. Thus, the device ID 802 serves to associate all of the account information of a particular patient 102 to a single IMD 104 which belongs to the patient 102 to which the account information pertains. Thus, it can be ensured that any transaction request for a particular IMD 104 will result in transactional charges being applied to the account of the patient 102 who possesses that same IMD 104. Furthermore, this device ID ensures that the correct set of session tokens are used when providing session tokens back to the IMD 104 as a result of the transaction.

The account information may also include a password 804. The password may be useful for authenticating a request so as to prevent someone other than the patient 102 who surreptitiously submits an electronic request with the device ID of the patient or places a phone call acting as the patient 102 from fraudulently attempting a transaction using the account of the patient 102.

The account information may include contact information 806 for the patient 102. This contact information 806 may be useful for completing credit card transactions, for submitting physical or electronic bills, for physical shipment of a memory device containing session tokens, and/or for contacting the patient 102 if necessary.

The account information may include payment related payment information as well. A payment method 808, such as a credit card, an intermediary service account such as one from the Paypal™ service, or bank account for a funds transfer may be present. A pre-paid credit balance 810 may be present, such as where the patient 102 is required to pay in advance in order to allow for subsequent automated replenishment of the session tokens. A post pay status 812 may be present, such as to authorize the transactional system 128 to bill the patient 102 for the transaction where the patient 102 qualifies.

The account information may also include a deliver method 814. The deliver method may specify that an electronic communication be used to deliver the session token. Examples of the delivery method information for an electronic communication may be a phone number for receiving a text message containing the session tokens, an email address for receiving an email containing the session tokens, or specify deliver to a dedicated application program on a downstream device of the patient 102 for receiving session tokens where the application is linked to the account. Another example of a delivery method is an instruction to physically ship a specified type of memory device containing the session tokens to an address within the contact information 806.

As discussed above, the account information of a given patient 102 may also include the data structure 404 that includes the session tokens that are associated with the IMD 104 corresponding to the device ID 802. Alternatively, the data structure is stored separately from the account information 800 but is associated back to the account of the patient 102, such as by being associated to the device ID 802.

FIG. 9 shows one example of a set of operations 900 that may be performed by the external device 110 where the external device determines whether to authorize a requested session. In these embodiments of the external device 110, the IMD 104 may be dependent upon the external device 110 for power, either in real time or for recharging, and the external device 110 provides power transmission only if the session being requested by the patient 102 is authorized.

Initially, the external device 110 detects a trigger for transmitting power to the IMD 104 at a trigger operation 902. This trigger may be the patient 102 requesting a session either by directly interface with the external device 110 or by using another device such as the computing device 111 that communicates with the external device 110. The external device 110 then determines whether the power transmission, and hence the session of performing the medical task(s) is authorized at a query operation 904. One manner of the external device determining whether power transmission is authorized is for the external device 110 to use session tokens in the same manner that is discussed above for the IMD. Thus, the external device 110 may determine whether it possesses a session token with an active status.

If the power transmission is authorized, then the external device 110 activates power transmission at activation operation 906. The external device 110 then detects the end of the session, such as by detecting that the time for a session has expired or by detecting that the patient 102 has requested that the session end at a detection operation 908. The external device 110 then deactivates power transmission.

Returning to query operation 904, where the power transmission is not authorized because no active session token is available, the external device may the proceed with the same request to replenish via a transaction with the transaction system 128 as discussed above with respect to the IMD 104 as shown at a request operation 910. Thus, the transactional system 128 may perform the same operations of FIG. 7 with respect to providing session tokens to the external device 110 for purposes of authorizing that a session be activated through the activation of power transmission by the external device 110. The external device 110 may receive the session tokens and then perform the same comparison and detection of matching session tokens already stored by the external device 110 in order to activate the already stored session tokens at the token operation 912.

The technical features and operations discussed above for authorizing an IMD 104 to activate the performance of medical task(s) during a session provide an opportunity to alter the pricing of the IMD 104. Because ongoing usage of the IMD 104 requires that a purchase of such usage be made subsequent to the initial purchase of the IMD 104, there is an ongoing revenue stream associated with the IMD 104. This ongoing revenue stream is not present where the IMD 104 is sold at full price but with no restriction on usage thereafter. Therefore, this ongoing revenue stream associated with the IMD 104 allows the IMD 104 to be sold at a reduced price, with any loss in revenue that has occurred at the initial sale being recovered through the usage charges being collected thereafter. Furthermore, the ongoing usage charges may exceed any initial loss in revenue from the reduced price of the IMD 104.

Additionally, the reduced price increases the population of patients 102 who can afford to purchase the IMD 104 and thereby increases the number of IMDs 104 that may be sold. For instance, patients who lack insurance that covers purchases of an IMD 104 may be able to afford the IMD 104 by paying out of pocket. This includes citizens of countries with an under-developed insurance industry or economy. Therefore, because the usage charges cover any loss of revenues from the initial sale at the reduced price, the overall revenue is increased because of the increased number of IMDs 104 that is sold due to the reduced price.

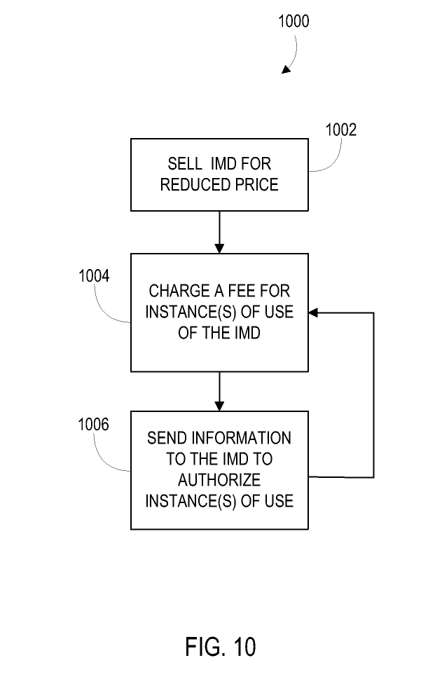

FIG. 10 illustrates this scenario 1000 where the IMD 104 is used to authorize the sessions for performing the medical task(s). Initially, the IMD 104 is sold at a reduced price at initial sale 1002. This price is reduced in relation to the price typically charged for the IMD 104 where the IMD has no further restriction on usage. Thereafter, a fee is then charged for instances of use of the IMD 104 at ongoing transaction 1004. The payment of the fee results in information, such as the session tokens discussed above, being send to the IMD 104 to authorize instances of use at an authorization 1006. These phases of the scenario 1000 then loop such that ongoing use of the IMD 104 results from ongoing fees being paid.

The scenario 1000 of FIG. 10 is also applicable to the external device 110 authorizing the sessions by determining whether to activate power transmission. The IMD 102 may still be sold at the reduced price, and the lost revenue is recovered by charging the fee necessary to authorize the external device 110 to transmit power to the IMD 104. In this scenario, the external device 110 is paired to the IMD 104 for purposes of power transfer while other external devices are not. Therefore, the IMD 104 can receive power in order to be operational only when the external device that is paired with the IMD 104 has been authorized to do so via the ongoing fees.

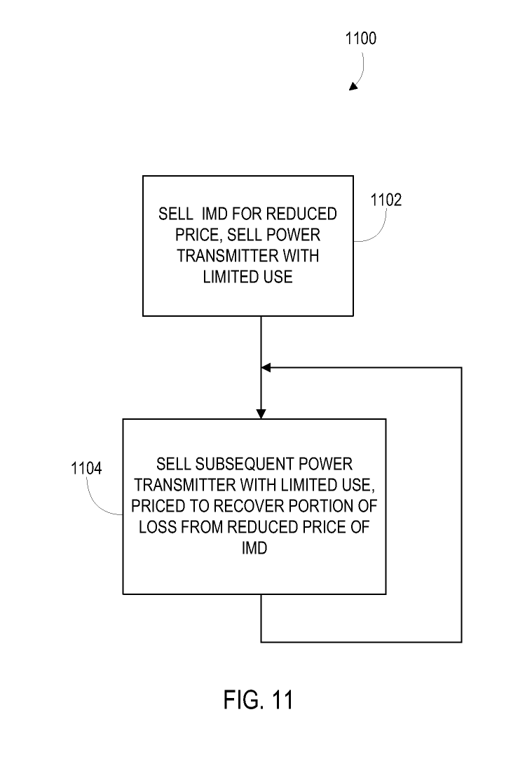

FIG. 11 shows a scenario where the authorization of the session is controlled by providing power from an external device 110 to the IMD 104, but rather than having the external device 110 utilize a replenishable feature, the external device 110 becomes unusable upon depleting a pre-set number of power transmissions. To continue further usage of the IMD 104, a new external device with the same pairing information for the IMD 104 is purchased. The external devices 110 may be priced such that at least a portion of the profit from the sale of an external device 110 serves to recover any revenue lost from the reduced price of the IMD 104.

Scenario 1100 begins by the IMD 104 being sold at the reduced price. An external device 110 that serves as the power transmitter for the IMD 104 is also sold or included in the purchase of the IMD 104 at a sale 1102. The external device 110 of this scenario 1100 has a limited number of power transmissions that it will provide. This may be implemented by the external device 110 being programmed with a number that is decremented after each power transmission session and once at zero prevents any further power transmissions from occurring.

Afterwards when the first external device 110 is fully depleted of power transmission sessions, another external device 110 that serves as a power transmitter and that has a limited number of power transmissions is sold at a sale 1104. This sale 1104 then recurs on an ongoing basis so long as the patient 102 continues to use the IMD 104. At least a portion of the profits on the sale of this subsequent power transmitter recovers at least a portion of the loss from the reduced price of the IMD 104. This recurrence of the sale 1104 allows the revenues initially lost at the sale 1102 to be substantially recovered.

FIG. 12 shows an example of logical operations that may be performed by the transactional system to account for unused session tokens within an IMD that has become unusable, such as because the end of life for the IMD has been reached or has stopped functioning for some other reason such as a non-functional battery. Upon the IMD becoming unusable, the patient may opt for a replacement IMD that operates on the basis of paying for sessions, or may opt for a full-price IMD that does not require payment per session, or may opt for no replacement.

Where the patient opts for a replacement IMD that requires payment for sessions to be authorized, the transactional system receives a request for a transfer of session tokens at a request operation 1202. The request may be generated by the external device that has communicated with the IMD prior to the IMD becoming non-functional to determine a last known number of remaining session tokens that have been activated and are not depleted. The external device may then be triggered to submit the request by the patient submitting information via a user interface that the IMD is non-functional. The request may specify that last known number of remaining active session tokens.

The transactional system looks up the account for the patient at account operation 1204 and changes the device ID to the replacement IMD that has been issued to the patient if that change has not already been made at a prior time at ID operation 1206. The transaction system then obtains an amount of session tokens from the pool of session tokens established for the replacement IMD that accounts for the last known remaining number of active session tokens of the non-functional IMD at token operation 1208. The transactional system changes the status of those obtained session tokens to unavailable, or for the alternative embodiments where pointers are used in place of states, the transactional system moves the pointer to a position beyond those obtained session tokens to signify that the obtained session tokens are no longer available for transfer at status operation 1210. The transactional system then transfers to obtained session tokens to the external device for delivery to the replacement IMD at a delivery operation 1212.

Where the patient opts for a full-price replacement IMD or for no replacement, the transactional system may receive a corresponding request at a request operation 1214. The request may again specify the last known number of remaining active session tokens. The transactional system then looks up the account of the patient at an account operation 1216 and provides a refund for the number of remaining active session tokens according to one of the specified payment methods for the account at a refund operation 1218.

While embodiments have been particularly shown and described, it will be understood by those skilled in the art that various other changes in the form and details may be made therein without departing from the spirit and scope of the invention.

What is claimed is:

1. A medical device comprising:
a communication circuit that receives external signals;
a medical circuit that performs a medical task during a session;
a storage element that contains a plurality of session tokens, the session tokens within the storage element having a state that either does authorize a session or a state that does not authorize a session;
a processor in communication with the communication circuit to receive a request for a session, the processor being in communication with the medical circuit to activate and deactivate a session, the processor being in communication with the storage element to access the session tokens, wherein the processor activates the session in response to the request upon detecting that a session token within the storage element has a state that does authorize the session.

2. The medical device of claim 1, wherein the processor detects that the session is authorized by detecting that a session token with an active state is present within the storage element, wherein the processor changes the state of the available active session token to an inactive state upon depletion of the available active session token.

3. The medical device of claim 2, wherein the plurality of session tokens includes session tokens with an inactive-used state and session tokens with an inactive-unused state, and wherein the processor changes the status of the available active session token to the inactive-used state.

4. The medical device of claim 3, wherein the processor receives a replenishment communication that includes a session token, compares the session token of the replenishment communication with the session tokens of the storage element that have the inactive-unused state, and when a session token with the inactive-unused state from the storage device matches the session token of the replenishment communication the processor then changes the state of the session token with the inactive-unused state to the active state.

5. The medical device of any of claim 1, wherein the session token authorizes a set number of sessions such that the session token is depleted upon completion of the set number of sessions.

6. The medical device of any of claim 1, wherein the session token authorizes a set amount of session time such that the session token is depleted upon completion of the set amount of session time.

7. The medical device of claim 1, wherein the session token authorizes a time period during which sessions are authorized such that the session token is depleted upon reaching the end of the time period.

8. The medical device of any of claim 1, wherein each session token comprises a series of randomly generated values.

9. The medical device of claim 1, wherein the storage element contains a bank that maintains a count representing an amount of usage, the session tokens representing an amount of usage, the processor being in communication with the storage element to access the session tokens, and wherein the processor detects that the session is authorized by detecting that the count of the bank is not depleted, the processor incrementing the count of the bank upon changing a state of a session token with an unused state to a used state.

10. A medical device comprising:
a communication circuit that receives external signals;
a medical circuit that performs a medical task during a session;
a storage element that contains a plurality of session tokens;
a processor in communication with the communication circuit to receive a request for a session, the processor being in communication with the medical circuit to activate and deactivate a session, the processor being in communication with the storage element to access the session tokens, wherein the processor maintains a pointer directed to one of the session tokens of the plurality and activates the session in response to the request upon detecting that the session token at a current position of the pointer authorizes the session.

11. The medical device of claim 10, wherein upon the session token at the current position of the pointer no longer authorizing a session and upon receiving a replenishment communication having a session token, the processor moves the pointer to a lower positioned session token of the plurality that matches the session token of the replenishment communication such that the session token at the position of the pointer authorizes a subsequent session while higher positioned session tokens no longer authorize subsequent sessions.

12. A medical system, comprising:
an external device that receives a request for a session;
an implantable medical device that receives the request for the session, that determines whether the requested session is authorized, and upon detecting that the requested session is authorized, then performs a medical task during the requested session, the implantable medical device storing a plurality of session tokens, the session tokens having a state that is either an active state or an inactive state, wherein the implantable medical device detects that the session is authorized by detecting that a session token has the active state.

13. The medical system of claim 12, wherein the external device provides a user interface for receiving the request for the session.

14. The medical system of any of claim 12, wherein the external device receives a wireless communication that provides the request for the session.

15. The medical system of claim 14, wherein the wireless communication is from a smartphone that provides a user interface for receiving the request for the session.

16. The medical system of claim 12, further comprising a remotely located transactional system that receives a replenishment request, the transactional system processing a payment for the replenishment request and delivering replenishment communication to the external device that authorizes sessions, wherein the external device delivers information from the replenishment communication to the implantable medical device.

17. The medical system of claim 16, wherein the replenishment communication is through a network.

18. The medical system of claim 16, wherein the replenishment communication is through an external memory device.

19. The medical system of claim 16, wherein the implantable medical device stores a plurality of session tokens and the transactional system stores a duplicate of the plurality of session tokens, wherein the session tokens stored by the implantable medical device have a state, wherein the implantable medical device detects that the requested session is authorized by detecting that a session token with an active state is present, the implantable medical device changing the state of the available active session token to an inactive-used state upon depletion of the available active session token, and wherein the information from the replenishment communication comprises a session token matching an inactive-unused state session token of the implantable medical device such that the implantable medical device changes the state of the inactive-unused session token to the active state upon receiving the information.

20. The medical system of any of claim 12, wherein the implantable medical device stores a plurality of session tokens, wherein the session tokens stored by the implantable medical device have a state, wherein the implantable medical device detects that the requested session is authorized by detecting that a session token with an active state is present, the implantable medical device changing the state of the available active session token to an inactive state upon depletion of the available active session token.

21. A method of performing a medical task during a session, comprising:
receiving a request for the session;
detecting whether the requested session is authorized by determining whether a session token of a plurality of session tokens stored within an implantable medical device authorizes the session where at least one of the session tokens of the plurality does not authorize the session; and
upon detecting that the requested session is authorized, then at the implantable medical device activating the session to perform the medical task.

22. The method of claim 21, wherein an external device sends the request for the session, and wherein the implantable medical device receives the request for the session and detects whether the requested session is authorized.

23. The method of claim 21, further comprising setting a state to active for a number of session tokens at a second implantable medical device equal to a number of session tokens that are active at the implantable medical device upon the implantable medical device becoming unusable.

24. The method of claim 21, further comprising generating a refund for a number of session tokens that are active at the implantable medical device upon the implantable medical device becoming unusable.

25. The method of any of claim 21, further comprising:
detecting whether the requested session is authorized by detecting whether a session token stored at the implantable medical device has an active state.

26. The method of claim 25, further comprising detecting that the session token with the active state has been depleted and then changing the state of the session token stored at the implantable medical device to an inactive state.

27. The method of claim 21, wherein the session token authorizes a set number of sessions such that the session token is depleted upon completion of the set number of sessions.

28. The method of claim 21, wherein the session token authorizes a set amount of session time such that the session token is depleted upon completion of the set amount of session time.

29. The medical device of claim 21, wherein the session token authorizes a time period during which sessions are authorized such that the session token is depleted upon reaching the end of the time period.

30. The method of any of claim 21, wherein each session token comprises a series of randomly generated values.

31. The method of any of claim 21, further comprising submitting a request to a transactional system to replenish the authorized sessions, receiving session tokens from the transactional system, comparing the session tokens received from the transactional system to session tokens stored by the implantable medical device that have an inactive-unused state, and changing the state of each unused inactive session token at the implantable medical device that matches a session token received from the transactional system to active.

32. The method of any of claim 21, wherein receiving the request for the session comprises receiving the request for the session at an external device that is in communication with a smartphone that sent the request.

33. A power transmission device for transmitting power to an implantable medical device that utilizes the power to generate stimulation signals, comprising:
a power transmission circuit;
a processor that activates and deactivates the power transmission circuit, the processor detecting a trigger to begin a power transmission session, determining whether the power transmission session is authorized, and activating the power transmission when the power transmission session is authorized.

34. The power transmission device of claim 33, wherein determining whether the power transmission session is authorized comprises determining whether a stored value representing the number of authorized power transmission sessions has reached zero.

35. A method of providing a medical task, comprising:
selling an implantable medical device that performs the medical task at a price less than a price that is charged when the implantable medical device is sold with unrestricted performances of the medical task;
subsequently charging a fee to authorize an amount of performance of the medical task by the implantable device;
upon charging the fee, sending session tokens to authorize the implantable medical device to perform the medical task; and
detecting at the implantable medical device whether a requested session of performing the medical task is authorized by determining whether a session token of a plurality of session tokens stored within an implantable medical device authorizes the session where at least one of the session tokens of the plurality does not authorize the session, a session token authorizing the session upon the implantable medical device receiving a session token that matches the stored session token.

36. The method of claim 35, wherein the implantable medical device compares the received session token to a stored undepleted session token and activates performance of the medical task when the session token matches the stored undepleted session token.

37. The method of claim 35, further comprising setting a state to active for a number of session tokens at a second implantable medical device equal to a number of session tokens that are active at the implantable medical device upon the implantable medical device becoming unusable.

38. The method of claim 35, further comprising generating a refund for a number of session tokens that are active at the implantable medical device upon the implantable medical device becoming unusable.

39. The method of claim 35, wherein sending session tokens comprises sending session tokens by a remotely located transactional system.

40. The method of claim 35, wherein sending session tokens comprises sending session tokens by an external device in direct communication with the implantable medical device.

41. A method of providing a medical task, comprising:
selling to a patient an implantable medical device that performs the medical task at a price less than a price that is charged when the implantable medical device is sold with unrestricted performances of the medical task, the implantable medical device having a power receiving circuit;
selling to the patient a first external power transmission device that has a power transmission circuit to provide power to the implantable medical device, the first external power transmission device having a pre-defined amount of power transmission, the pre-defined amount of power transmission being less than an amount of power transmission needed by the implantable device for a device lifetime; and
subsequent to selling the first external power transmission device, selling to the patient a second external power transmission device that has a power transmission circuit to provide power to the implantable medical device, the second external power transmission device having a pre-defined amount of power transmission, the pre-defined amount of power transmission being less than an amount of power transmission needed by the implantable device for a device lifetime.

42. The method of claim 41, wherein the implantable medical device comprises a rechargeable battery and wherein the power transmission recharges the rechargeable battery.
